(19) United States
(12) Patent Application Publication
(10) Pub. No.: US 2017/0310907 A1
(43) Pub. Date: Oct. 26, 2017

(54) FLAT LENS IMAGING DEVICES AND SYSTEMS

(71) Applicant: Microsoft Technology Licensing, LLC, Redmond, WA (US)

(72) Inventor: Michael Dongxue Wang, Bellevue, WA (US)

(21) Appl. No.: 15/134,210

(22) Filed: Apr. 20, 2016

(51) Int. Cl. H04N 5/33

(52) U.S. Cl. CPC H04N 5/33

(57) ABSTRACT

Disclosed herein are electronic devices having flat lenses. The flat lens may be combined with an infrared (IR) emitter, an IR sensor, or an image sensor, and/or one or more additional optical lenses or filters. The flat lens may provide a more compact footprint over a conventional curved optical lens. Additionally, the flat lens may be configured to bend light instantaneously, rather than gradually as the light passes through the lens. This may be advantageous in reducing the number of optical lenses within the electronic device and/or size (e.g., thickness) of the overall lens arrangement (as well as the size of the overall electronic device), therein allowing for a more compact configuration for the electronic device.

### BACKGROUND

Current design trends for electronic devices such as tablet computers, mobile phones, and digital cameras include designs having an increase in power, a decrease in size (e.g., height, length, and/or width), and an increase in speed. As the size of the electronic device is reduced, certain internal device components are positioned closer together. This provides for challenges in manufacturing design. Specifically, there are manufacturing and operational challenges for cameras and camera lenses within the electronic device as the size (e.g., height, length, and/or width) of the electronic device is reduced.

### SUMMARY

Flat lens imaging devices and systems are disclosed herein. In one embodiment, a device includes an infrared emitter configured to emit at least one wavelength of infrared light spectrum across a radiation angle. The device further includes a flat lens configured to receive the infrared light from the infrared emitter and adjust the radiation angle for the at least one wavelength of infrared light, providing an adjusted radiation angle, therein performing beam shaping functions.

In another embodiment, a device includes an infrared sensor, and a flat lens configured to receive infrared light and adjust at least one wavelength of the infrared light onto a single location of the infrared sensor.

In another embodiment, an infrared camera system includes an infrared sensor, a flat lens imaging device configured to receive infrared light from one or more targets and adjust at least one wavelength of the infrared light to focus the infrared light onto a single location of the infrared sensor, and a processor configured to analyze the at least one wavelength of infrared light received at the single location of the infrared sensor.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWING FIGURES

For a more complete understanding of the disclosure, reference is made to the following detailed description and accompanying drawing figures, in which like reference numerals may be used to identify like elements in the figures.

FIG. 1 depicts an example of a flat lens having a substrate and optical antennas positioned on a surface of the substrate.

FIG. 2 depicts an example of an IR emitter and a flat lens.

FIG. 3 depicts an example of an IR sensor and a flat lens.

FIGS. 4A and 4B depict examples of IR sensors, flat lenses, and curved optical lenses.

FIG. 5 depicts an example of a flat lens, color filter, and detector.

FIG. 6 is a block diagram of a computing environment in accordance with one example for implementation of the disclosed flat lens imaging devices and systems.

While the disclosed devices and systems are representative of embodiments in various forms, specific embodiments are illustrated in the drawings (and are hereafter described), with the understanding that the disclosure is intended to be illustrative, and is not intended to limit the claim scope to the specific embodiments described and illustrated herein.

### DETAILED DESCRIPTION

Disclosed herein are electronic devices having flat lenses. A flat lens may refer to an optical lens having a flat lens surface without surface curvature. The flat lens may provide a more compact footprint over a conventional curved optical lens. Additionally, the flat lens may be configured to bend (e.g., refract or diffract) light instantaneously, rather than refract light at a curved surface as the light passes through the lens. This may be advantageous in reducing the number of optical lenses within the electronic or optical device, such as by reducing the size (e.g., thickness) of the overall lens system (as well as the size of the overall electronic device), therein allowing for a more compact configuration for the electronic device.

As disclosed herein, the flat lens imaging device may be combined with an infrared (IR) emitter, an IR sensor, or an image sensor, and/or one or more additional optical lenses or filters.

Such a flat lens imaging device or system may be useful in any electronic device having an optical lens. In some examples, the flat lens may be incorporated into a system having an IR camera or IR emitter. In certain examples, the IR camera or IR emitter is installed within a personal computer, server computer, tablet or other handheld computing device, laptop or mobile computer, gaming system, communication device such as a mobile phone, digital camera, multiprocessor system, microprocessor-based system, set top box, programmable consumer electronic, network PC, minicomputer, mainframe computer, or audio or video media player. In certain examples, the flat lens may be incorporated within a wearable electronic device, wherein the device may be worn on or attached to a person's body or clothing. The wearable device may be attached to a person's shirt or jacket; worn on a person's wrist, ankle, waist, or head; or worn over their eyes or ears. Such wearable devices may include a watch, heart-rate monitor, activity tracker, or head-mounted display.

### Examples of Flat Lens Imaging Devices and Systems

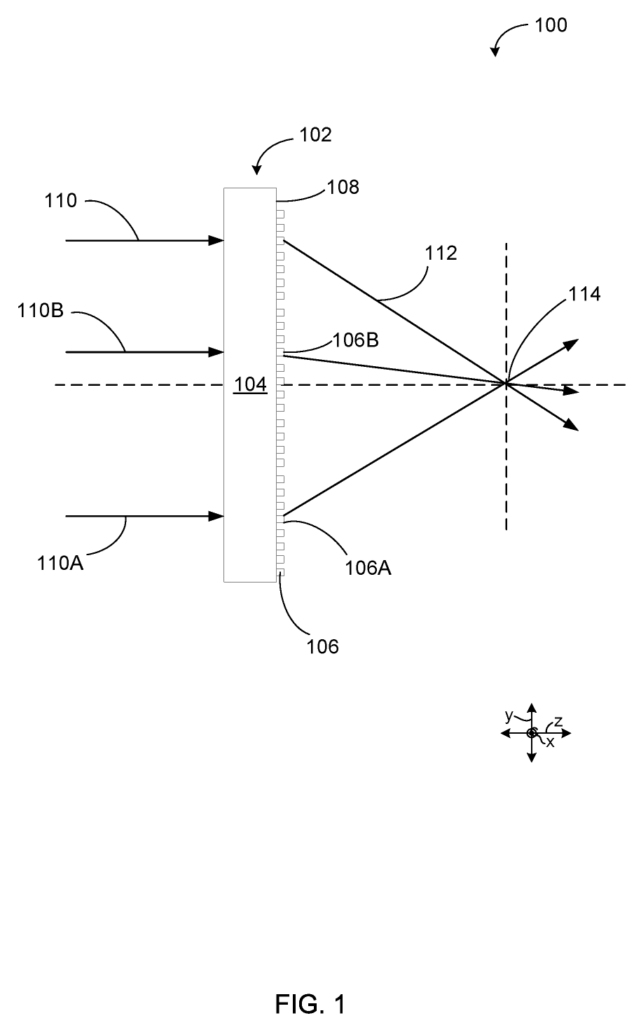

FIG. 1 depicts an example 100 of a flat lens imaging device configured to bend (e.g., refract or diffract) light through secondary optical emission using optical antennas, rather than refract light with a curved lens surface as the light passes through the lens. This is advantageous in reducing the number of lenses within the electronic device and/or size (e.g., thickness) of the overall lens system (as well as the size of the overall electronic device). For example, the overall thickness of the flat lens imaging device (as depicted in the z-direction in FIG. 1) may be 1-100 nanometers (nm), 10-100 nm, or 25-75 nm.

In certain examples, as depicted in FIG. 1, the flat lens imaging device 102 may include a substrate 104 and optical antennas 106 positioned on a surface 108 of the substrate 104. The substrate 104 may include glass or silicon. The optical antennas 106 may be configured to refract entering light 110 so that the emitted light 112 from the optical antennas is focused on a single focal plane or position 114 to form an imaging point. Light at different wavelengths (e.g., within the visible color spectrum or within the infrared spectrum) responds to the surface of a lens differently. The optical antennas 106 of the flat lens imaging device 102 can be designed or configured to compensate for the wavelength differences and produce a consistent effect, such as bending different wavelengths of light onto a single location without chromatic aberrations. In other words, the optical antennas 106 can be designed or configured to focus certain wavelengths of light at a same, desired angle to fit the desired need for the flat lens.

This is advantageous, as the flat lens imaging device 102 eliminates the need to pass light through multiple conventional lenses in order to achieve a similar outcome (i.e., concentrating different wavelengths of light on a particular location). This is also advantageous as the flat lens 102 is considerably thinner than the conventional lens arrangement, e.g., at the magnitude of a nanometer. As such, the flat lens can be installed within a smaller or thinner electronic device than the conventional lens arrangement.

The angle of refraction may be variably controlled by the antennas' 106 material, shape, size, orientation, and position on the surface 108 of the substrate 104 through secondary optical wavelet emissions from the optical antennas. These properties of the antennas are designed and manufactured using nanotechnologies, for example, such that the entering light 110A at the edge of the lens is refracted more than entering light 110B near the middle of the lens. In other words, the refraction angle may be different based on the location of the optical antenna on the glass substrate (e.g., an antenna 106A located at an edge of the flat lens may bend certain wavelengths of light at a larger angle than an antenna 106B located within the middle of the flat lens.)

In certain examples, the optical antennas 106 are nanoantennas, wherein the height, length, and width of each antenna is in the range of 0.1-100 nanometers, 0.1-10 nanometers, or 1-10 nanometers. The composition of the antennas 106 may include one or more metals (e.g., gold). In other examples, the composition of the antennas 106 may include a dielectric material rather than a metal. In some examples, the material or composition of the antennas 106 includes an electrically tunable (e.g., focus-tunable) material. This electrically tunable material may be advantageous in providing an adjustable focal length through electrical manipulation of the radius (and therein negating a potential need for a multi-lens system). The electrically tunable material may include one or more elastic polymer materials.

The orientation of the antennas 106 may include positioning the antennas 106 on the surface 108 of the substrate 104 in concentric rings. Additionally, the two-dimensional shape (as viewed along the x-y plane) of each antenna 106 may be circular, square, rectangular, or v-shaped.

In certain alternative examples, the flat lens imaging device may include metamaterials, e.g., electromagnetic structures engineered, patterned at subwavelength scales and configured to bend certain wavelengths of light at a desired angle such that the light ends up on a single focal plane. The metamaterials may include periodic arrays of unit cells having inductive-capacitive resonators and conductive wires.

In additional alternative examples, the substrate may include one or more plastic compositions configured as a membrane that diffracts rather than refracts the light.

In yet other examples, the substrate of the flat lens imaging device includes a plurality of nanometer-thick metallic layers. The plurality of layers may include alternating layers of metallic material. For example, a first layer may include silver and a second layer may include titanium dioxide. The first and second layer may be repeated multiple times to form the overall substrate (e.g., a bi-metallic “sandwich”).

As disclosed herein, the flat lens imaging device may be configured to refract or diffract visible and/or infrared (IR) light or near-infrared (NIR) light. Visible light may refer to wavelengths within the electromagnetic spectrum from 390 nm to 700 nm. Infrared light may refer to wavelengths within the electromagnetic spectrum from 700 nm to 1 mm. Near-infrared light may refer to a subset of wavelengths within the infrared spectrum near the visible light spectrum (e.g., 700 nm to 2500 nm).

### Examples of Emitter Devices and Systems

In certain examples, the flat lens imaging device or system may be included within an electronic device having a light emitter (e.g., a visible light emitter or IR emitter). In one example, the flat lens imaging device is coupled with an IR emitter. The IR emitter may be used in an electronic device in several industries such as automotive, coating, glass, printing, plastics, food, wood, or textile industries. For example, within the automotive industry, an IR emitter may be used for night-vision applications.

In another example, the flat lens imaging device is coupled with a visible light emitter. For example, the flat lens imaging device may be positioned adjacent to a headlamp (e.g., an automotive headlamp), wherein the flat lens imaging device may be designed to bend visible light emitted from the headlamp. This may be advantageous in beam shaping the visible light with better cosmetic effects in comparison to a conventional headlamp (e.g., conventional automotive headlamp). In certain examples, the visible light emitter is a light emitting diode (LED) that generates at least one wavelength of light within the visible spectrum. Other visible light emitters are also possible.

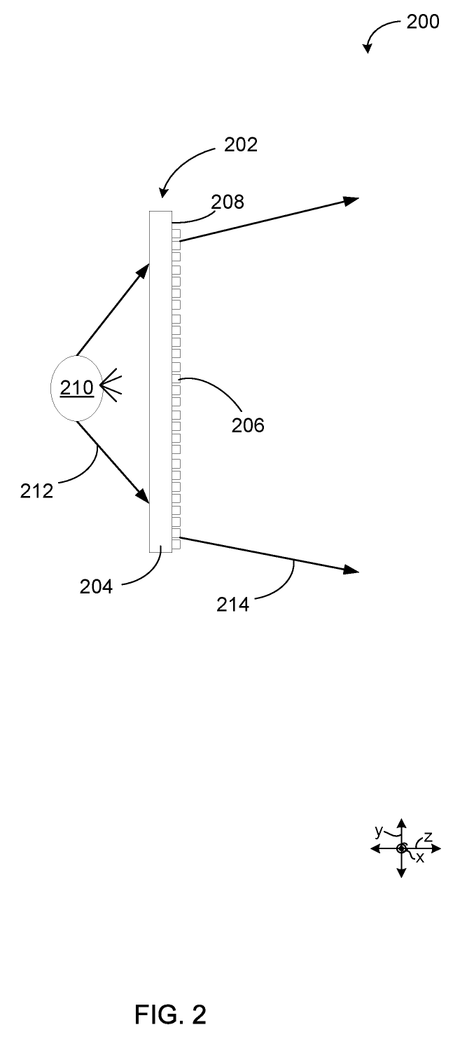

FIG. 2 depicts an example device or system 200 including a flat lens imaging device 202 and an IR emitter 210. In this example, the flat lens imaging device 202 includes a substrate 204 and optical antennas 206 (e.g., nanoantennas) affixed to a surface 208 of the substrate 204. The IR emitter 210 may provide a source of light energy within the infrared spectrum. For example, the IR emitter 210 may be a light emitting diode (LED) that is used to transmit an infrared signal (e.g., from a remote control). The IR emitter may generate infrared light that transmits information and commands from one device to another.

As depicted in FIG. 2, the IR emitter 210 (e.g., the LED diode) emits at least one wavelength of light within the IR spectrum. For example, multiple different IR wavelengths with full width at half maximum (FWHM) at 30 nm-50 nm are emitted. Based on the construction of the IR emitter, the light 212 may be emitted across a wide or obtuse angle (e.g., greater than 90 degrees, 90-180 degrees, 120-180 degrees, 100-140 degrees, or 120 degrees). In certain examples, the LED emission exhibits a lambertian profile. This angle of emitted light from the IR emitter may be referred to as the radiation angle of the IR emitter. A wide radiation angle of light may be undesirable in certain circumstances, such as where a focused transmission of light is needed.

In such circumstances, the flat lens imaging device 202 may be positioned in front of the IR emitter 210 to beam-shape, (e.g., bend or refract), certain IR wavelengths of light 212 and narrow the angle of emitted light (e.g., from an obtuse to an acute angle). The flat lens imaging device 202 (and the optical antennas 206 of the flat lens imaging device 202, in certain examples) may be configured to bend or shape the IR light to a desired, adjusted radiation angle. The adjusted IR light 214 results in an overall narrowed radiation angle of emitted light from the IR emitter 210. In certain examples, the adjusted radiation angle of emitted light from the IR emitter 210 may be less than 120 degrees, less than 90 degrees, less than 60 degrees, 30-120 degrees, 30-90 degrees, 45-90 degrees, or 60 degrees. In certain examples, the adjusted radiation angle is an acute angle. This is advantageous (and an improvement over an IR emitter without a flat lens imaging device), as certain wavelengths of IR light are focused, and potentially concentrated on a desired target.

In certain examples, the flat lens imaging device 202 may abut a surface of the IR emitter 210. In other examples, the flat lens imaging device 202 may be positioned within a certain distance of the IR emitter (e.g., within 10 mm, 1 mm, 0.1 mm, or 0.01 mm). In some examples, the flat lens imaging device 202 is combined or integrated with the emitter (e.g., IR emitter 210). The integration may be done at the wafer level using conventional integrated circuit technology. This is advantageous in providing a device or system that is considerably thinner than a conventional lens arrangement. As such, the flat lens device and emitter can be installed within a smaller or thinner electronic device than the conventional lens arrangement.

### Examples of Sensor Devices and Systems

The flat lens may be included within an electronic device having a sensor (e.g., a visible light sensor or an IR sensor). In certain examples, the sensor is an IR sensor. The IR sensor may be part of a thermographic or IR camera. IR sensors or cameras are configured to measure the amount of black body radiation emitted by an object within the infrared wavelength spectrum. The higher the object's temperature, the more infrared radiation may be emitted as black body radiation. The IR camera may even operate in total darkness, as the amount of ambient light does not matter. The IR sensor or camera having the flat lens arrangement may be a cooled IR sensor or an uncooled IR sensor. Cooled sensors may be contained within a vacuum-sealed case and cryogenically cooled. Uncooled sensors may operate at ambient temperature, and measure changes in resistance, voltage, or current when heated by infrared radiation.

In certain examples, the IR sensor or IR camera is used for night vision, building inspection, fault diagnosis, law enforcement, thermography (e.g., medical imaging), automotive night vision, chemical imaging, meteorology (e.g., thermal images from weather satellites), or astronomy.

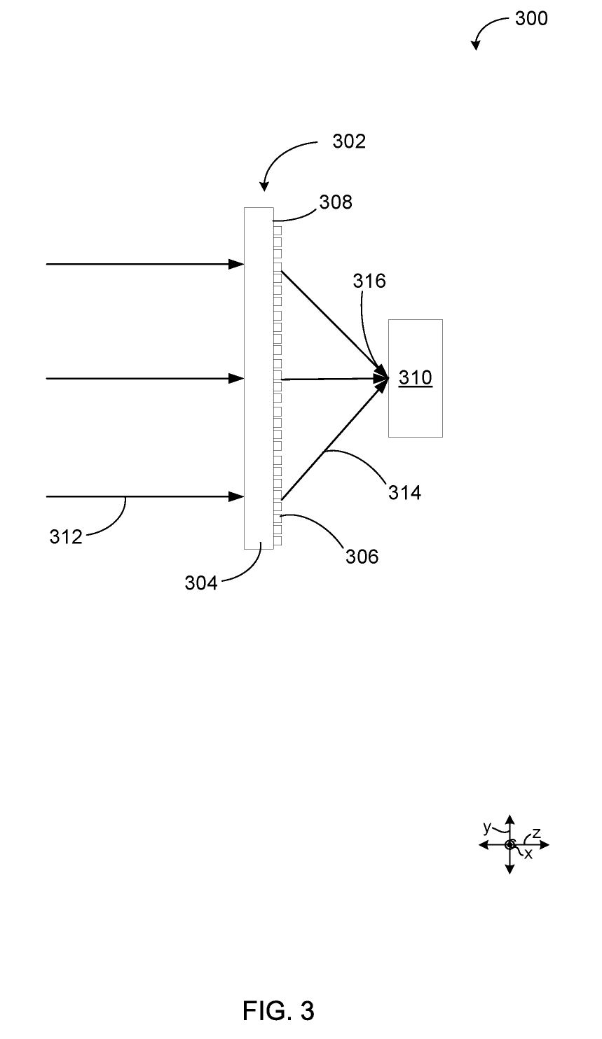

FIG. 3 depicts an example device or system 300 including a flat lens imaging device 302 and an IR sensor 310. Like the examples in FIGS. 1 and 2, the flat lens imaging device 302 includes a substrate 304 and optical antennas 306 (e.g., nanoantennas) affixed to a surface 308 of the substrate 304. Other flat lens imaging devices are also possible (as described above).

In this example, IR light 312 from an external source is refracted by a flat lens imaging device 302, and the refracted light 314 is captured by the IR sensor 310. The flat lens imaging device 302 is positioned in front of the IR sensor 310 to refract certain IR wavelengths of light 312 to a focal plane or position 316 of the IR sensor 310. The flat lens imaging device 302 may be positioned within a certain distance of the IR sensor (e.g., within 10 mm, 1 mm, 0.1 mm, or 0.01 mm).

The optical antennas 306 of the flat lens imaging device 302 may be configured to compensate for the different IR wavelengths and different locations of the IR light 312 passing through the flat lens imaging device 302 in front of the IR sensor 310, therein focusing the different wavelengths of light onto a single location 316.

This device or system 300 is advantageous as a smaller IR sensor may be provided (as the desired light is refracted to central location), fewer optical lenses may be used therein allowing for a thinner device (due to the construction of the flat lens imaging device itself), a smaller overall electronic device may be constructed (based on the thinness of the flat lens and the reduced size of the IR sensor), and/or a less costly electronic device may be constructed (based on the flat lens itself and reduced size of the IR sensor).

These configurations of IR sensors and flat lens imaging devices (and, in some examples, additional optical lenses, as discussed below) may also be advantageous in providing an IR device or system without the need for an additional IR filter device (e.g., IR bandpass filter). A bandpass filter may refer to a device that passes frequencies or wavelengths within a certain range while rejecting or attenuating frequencies/wavelengths outside of that range. Certain active bandpass filters require an external source of power or employ active components such as transistors or integrated circuits, while passive bandpass filters may include capacitors or inductors to filter certain frequencies/wavelengths.

A conventional infrared bandpass filter may include stacks of thin layers of different optical materials in controlled thicknesses. Certain wavelengths of IR light may be reflected at each film interface, therein constructively providing high reflectance for certain wavelengths, and destructively providing high transmittance for other wavelengths. Long wave pass, short wave pass and bandpass filters may be designed and manufactured in this way.

In the examples disclosed herein, a conventional IR bandpass filter is not provided or necessary. Instead, the flat lens imaging device itself can be designed or configured to provide filtering functionality such that certain wavelengths of IR light are transmitted through the flat lens imaging device, while others are blocked (e.g., reflected). In other words, the flat lens imaging device may be configured to perform multiple functions (e.g., filtering IR light in certain wavelengths and imaging unfiltered IR light in other wavelengths). This is accomplished based upon the materials used to make the flat lens imaging device (e.g., a silicon substrate or the metallic optical antennas).

The lack of the conventional IR bandpass filter is advantageous in multiple ways. To begin, fewer devices are needed to image and filter IR light. This allows for a thinner IR system and a potentially thinner/smaller overall electronic device. This also may allow for a less costly electronic device to be constructed (based on the absence of the additional device/conventional IR filter). Additionally, the dual-functionality of the flat lens imaging device allows for the optical antennas to be configured to bend only the desired wavelength or wavelengths of unfiltered IR light, while remaining wavelengths of IR light are filtered.

In addition to, or in the alternative from, an IR system without a separate IR filter device, the IR system may be configured to engineer or minimize the chief ray angle (CRA) of the IR system (e.g., a camera having an IR sensor). The chief ray may refer to the meridional ray that begins at the edge of the object, and passes through the center of the aperture stop. This ray crosses the optical axis at the locations of the pupils. As such, chief rays are equivalent to the rays in a pinhole camera. The distance between the chief ray and the optical axis at an image location may define the size of the image.

In certain examples, the flat lens imaging device may be configured to provide a telecentric lens, wherein the chief ray has zero angle with respect to the optical axis as it passes through the exit pupil and arrives at the image plane. This may be accomplished through the arrangement of the optical antennas positioned on the substrate of the flat lens imaging device. In other words, the flat lens may be configured to produce an orthographic view of a subject. This may be advantageous over conventional lens systems, as the number or thickness of the lenses needed to create the telecentric lens may be reduced.

Examples of Devices and Systems with Additional Lenses

In certain examples, one or more additional optical lens may be provided in addition to the flat lens imaging device to further assist in imaging the light (e.g., visible or IR light) produced by an emitter (e.g., visible light emitter or IR emitter) or received by a sensor (e.g., visible light sensor or IR sensor). The at least one additional optical lens may be a curvature lens. One or both of the surfaces of the conventional curvature lens may be curved (e.g., concave or convex). In certain examples, the surface of the curvature lens closest to the source of the light ray be emitted or received is convex or concave. In other examples, the surface farthest from the source of the light ray is convex or concave. In yet other examples, both surfaces of the curvature lens are convex. In other examples, both surfaces of the curvature lens are concave.

The curvature lens may be advantageous to the system including the flat lens imaging device, as the curvature lens may assist in further shaping the beam of light (e.g., IR light) to the desired parameters of the electronic device (e.g., IR camera). In some examples, the curvature lens may assist in shaping wavelengths of IR light also adjusted by the flat lens imaging device. In alternative examples, the curvature lens may assist in shaping different wavelengths of light that are not adjusted by the flat lens such that the multiple wavelengths of light are all adjusted or shaped to the same degree (e.g., to the same focal point or location of an IR sensor). For instance, the optical antennas of the flat lens may only be configured to adjust certain IR wavelengths. Thus, an additional lens may be needed to beam shape the IR light at additional wavelengths.

In certain examples, the optical imaging system having the flat lens imaging device and additional optical lens may be configured using conventional optical lens programming software, such as Zemax or Code V.

In certain examples, the at least one additional optical lens may be a diffraction lens. The diffraction lens may include one or more slits or apertures. In other examples, the diffraction lens may be a diffraction grating. Such diffraction lenses may be advantageous in combination with the flat lens imaging device, as the diffraction lens may assist in further shaping the beam of IR light to the desired parameters of the electronic device (e.g., IR camera). In some examples, the diffraction lens may assist in shaping certain wavelengths of IR light based on the dimensions of the slit, aperture, or grating. In some examples, the diffraction lens may assist in shaping wavelengths of IR light that are not adjusted by the flat lens. For instance, the optical antennas (e.g., nanoantennas) of the flat lens may be configured to only adjust certain IR wavelengths. Thus, an additional lens may be provided to beam shape or adjust IR light at additional wavelengths.

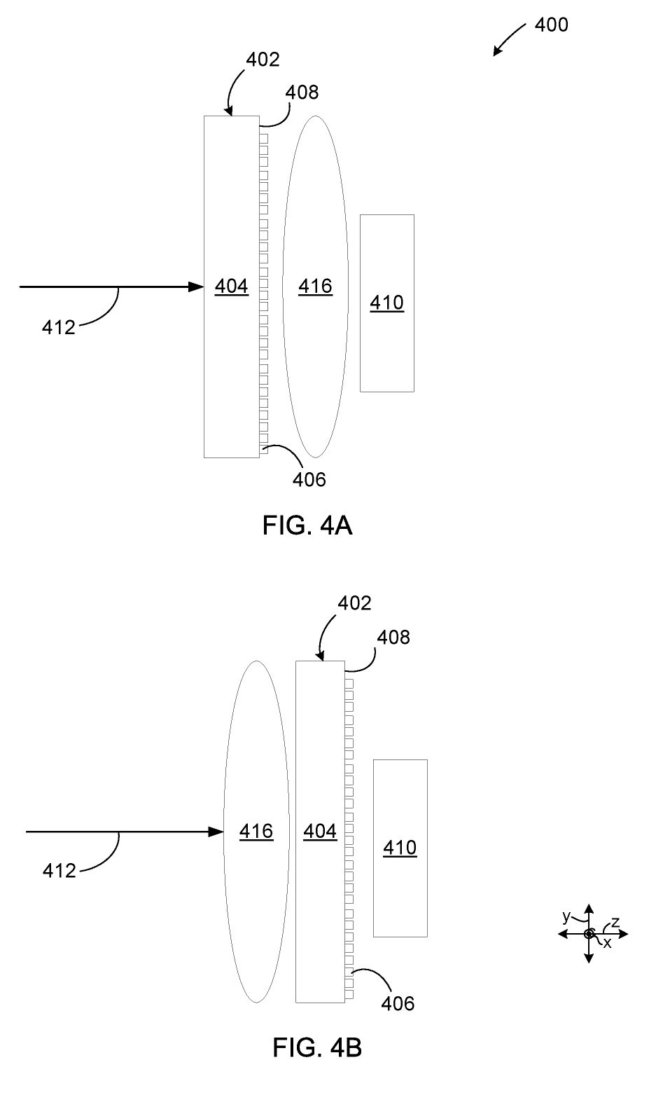

FIGS. 4A and 4B depict examples 400 of an IR sensor 410, flat lens 402 having a substrate 404 and optical antennas 406 on surface 408 of the substrate 404, and an additional optical lens 416. The additional optical lens 416 may be a curvature lens or a diffraction lens as described above. The positioning of the additional optical lens 416 relative to the IR sensor 410 and flat lens 402 is configurable. In FIG. 4A, IR light 412 from an external source is received by the flat lens 402 and then the additional optical lens 416 before being received by the IR sensor 410. The positioning of the flat lens 402, additional optical lens 416, and IR sensor 410 in FIG. 4A are configurable. For example, a surface 408 of the flat lens 402 may be positioned to abut a first surface of the optical lens 416. The flat lens 402 may cover a surface or at least part of a surface of the optical lens 416. Alternatively, the surface 408 of the flat lens 402 may be positioned within a certain distance of the first surface of the optical lens 416 (e.g., within 10 mm, 1 mm, 0.1 mm, or 0.01 mm). The second surface of the optical lens 416 may be positioned to abut a surface of the IR sensor 410. Alternatively, the second surface of the optical lens 416 may be positioned within a certain distance of the surface of the IR sensor 410 (e.g., within 10 mm, 1 mm, 0.1 mm, or 0.01 mm).

Alternatively, in FIG. 4B, IR light 412 from an external source is received by the optical lens 416 and then the flat lens 402 before being received by the IR sensor 410. The positioning of the flat lens 402, additional optical lens 416, and IR sensor 410 in FIG. 4B is configurable. For example, a surface of the optical lens 416 may be positioned to abut a first surface of the flat lens 402. The optical lens 416 may cover a surface or at least part of a surface of the flat lens 402. Alternatively, the surface of the optical lens 416 may be positioned within a certain distance of the first surface of the flat lens 402 (e.g., within 10 mm, 1 mm, 0.1 mm, or 0.01 mm). The second surface of the flat lens 402 may be positioned to abut a surface of the IR sensor 410. Alternatively, the second surface of the flat lens 402 may be positioned within a certain distance of the surface of the IR sensor 410 (e.g., within 10 mm, 1 mm, 0.1 mm, or 0.01 mm).

In yet another example, the flat lens imaging device may be combined with a color filter and a sensor or detector. The color filter may be configured to block or filter certain wavelengths of visible light from reaching the sensor or detector. This may be advantageously combined with the flat lens imaging device such that only specific wavelengths of light (e.g., IR or visible) are configured to be bent (e.g., refracted) and collected at a surface of the sensor. In certain examples, the flat lens imaging device, color filter, and the sensor/detector (e.g., a complementary metal-oxide-semiconductor or CMOS sensor) may be combined or integrated together. The integration may be done at the wafer level using conventional integrated circuit technology. This is advantageous in providing a device or system that is considerably thinner than a conventional lens arrangement. As such, the flat lens device, color filter, and the sensor/detector may be installed within a smaller or thinner electronic device than the conventional lens arrangement.

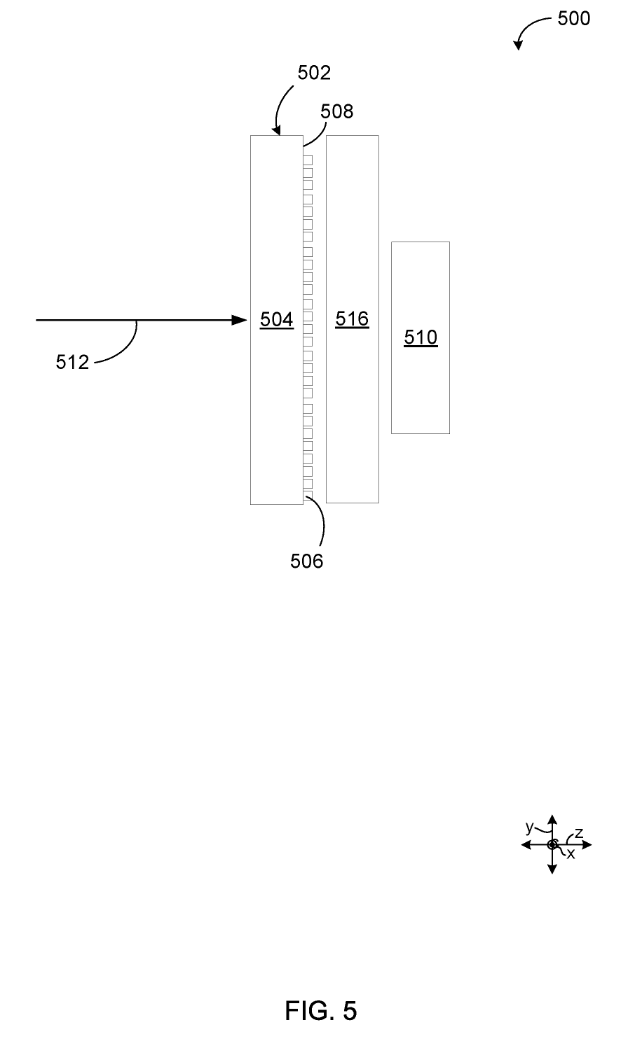

FIG. 5 depicts an example 500 of a flat lens 502 having a substrate 504 and optical antennas 506 on a surface 508 of the substrate 504, a color filter 516, and a sensor 510. In some examples, the sensor 510 is an IR sensor. In other examples, the sensor 510 is an image sensor. The image sensor 510 may be an active-pixel sensor having an integrated circuit with an array of pixel sensors, each pixel including a photodetector and an active amplifier. Such active-pixel sensors may be included within mobile phone cameras, computer or web cameras, or digital pocket cameras (e.g., digital single-lens reflex cameras). In certain examples, the active-pixel sensor is a complementary metal-oxide-semiconductor (CMOS) sensor.

Additional optical lenses may also be included with the flat lens 502, color filter 516, and sensor 510. The arrangement of the flat lens 502, color filter 516, and any additional optical lenses in front of the sensor 510 is configurable. As depicted in FIG. 5, visible light and/or IR light from an external source is received first by the flat lens 504 and then the color filter 516 before being received by the active-pixel sensor 510 (e.g., CMOS sensor). A surface 508 of the flat lens 502 may be positioned to abut a first surface of the color filter 516. Alternatively, the surface 508 of the flat lens 502 may be positioned within a certain distance of the first surface of the color filter 516 (e.g., within 10 mm, 1 mm, 0.1 mm, or 0.01 mm). The second surface of the color filter 516 may be positioned to abut a surface of the active-pixel sensor 510. Alternatively, the second surface of the color filter 516 may be positioned within a certain distance of the surface of the active-pixel sensor 510 (e.g., within 10 mm, 1 mm, 0.1 mm, or 0.01 mm).

The addition of the flat lens 510 to system including a color filter 516 and image sensor 510 may be advantageous over contemporary camera systems in providing an optical zoom lens with minimized color aberrations or without chromatic aberrations. Additionally, the system may be configured at different focal lengths (e.g., optical zoom) with a flat lens having an electrically tunable material.

The amount of optical zoom may be improved or at least maintained within a smaller footprint. As noted above, the flat lens imaging device may be thinner than conventional lenses, and the system may require fewer overall lenses and filters in front of the sensor. These improvements allow for a thinner camera system, and a potentially thinner overall electronic device.

### Exemplary Computing Environment

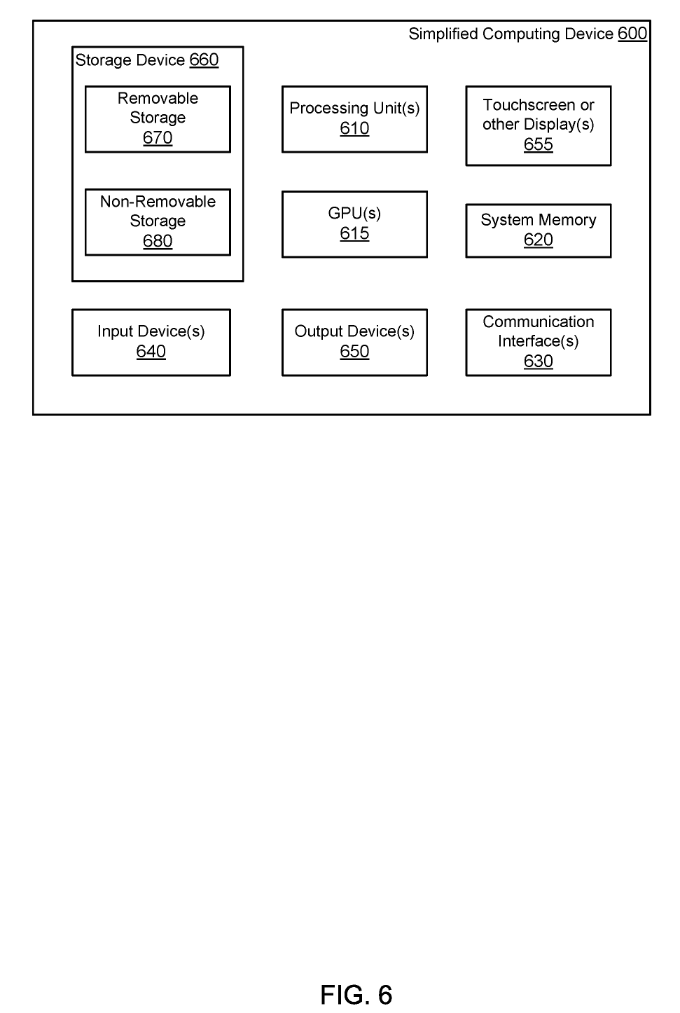

With reference to FIG. 6, the flat lens arrangements as described above may be incorporated within an exemplary electronic device or computing environment 600. The computing environment 600 may correspond with one of a wide variety of computing devices having a flat lens, including, but not limited to, IR emitters or IR cameras installed within personal computers (PCs), server computers, tablet and other handheld computing devices, laptop or mobile computers, gaming system, communications devices such as mobile phones, digital cameras, multiprocessor systems, microprocessor-based systems, set top boxes, programmable consumer electronics, network PCs, minicomputers, mainframe computers, or audio or video media players. In certain examples, the computing environment 600 is a wearable electronic device having an IR emitter or IR camera, wherein the device may be worn on or attached to a person's body or clothing.

The computing environment 600 has sufficient computational capability and system memory to enable basic computational operations. In this example, the computing environment 600 includes one or more processing unit(s) 610, which may be individually or collectively referred to herein as a processor. The computing environment 600 may also include one or more graphics processing units (GPUs) 615. The processor 610 and/or the GPU 615 may include integrated memory and/or be in communication with system memory 620. The processor 610 and/or the GPU 615 may be a specialized microprocessor, such as a digital signal processor (DSP), a very long instruction word (VLIW) processor, or other microcontroller, or may be a general purpose central processing unit (CPU) having one or more processing cores. The processor 610, the GPU 615, the system memory 620, and/or any other components of the computing environment 600 may be packaged or otherwise integrated as a system on a chip (SoC), application-specific integrated circuit (ASIC), or other integrated circuit or system.

The computing environment 600 may also include other components, such as, for example, a communications interface 630. One or more computer input devices 640 (e.g., pointing devices, keyboards, audio input devices, video input devices, haptic input devices, or devices for receiving wired or wireless data transmissions) may be provided. The input devices 640 may include one or more touch-sensitive surfaces, such as track pads. Various output devices 650, including touchscreen or touch-sensitive display(s) 655, may also be provided. The output devices 650 may include a variety of different audio output devices, video output devices, and/or devices for transmitting wired or wireless data transmissions.

The computing environment 600 may also include a variety of computer readable media for storage of information such as computer-readable or computer-executable instructions, data structures, program modules, or other data. Computer readable media may be any available media accessible via storage devices 660 and includes both volatile and nonvolatile media, whether in removable storage 670 and/or non-removable storage 680. Computer readable media may include computer storage media and communication media. Computer storage media may include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by the processing units of the computing environment 600.

While the present claim scope has been described with reference to specific examples, which are intended to be illustrative only and not to be limiting of the claim scope, it will be apparent to those of ordinary skill in the art that changes, additions and/or deletions may be made to the disclosed embodiments without departing from the spirit and scope of the claims.

The foregoing description is given for clearness of understanding only, and no unnecessary limitations should be understood therefrom, as modifications within the scope of the claims may be apparent to those having ordinary skill in the art.

### Claim Support Section

In a first embodiment, a device comprises an infrared emitter configured to emit at least one wavelength of infrared light across a radiation angle, and a flat lens imaging device configured to receive the infrared light from the infrared emitter and narrow the radiation angle for the at least one wavelength of infrared light, providing an adjusted radiation angle.

In a second embodiment, with reference to the first embodiment, the flat lens imaging device comprises a substrate and a plurality of optical antennas positioned on a surface of the substrate, wherein the optical antennas are configured to adjust the radiation angle of the at least one wavelength of infrared light emitted from the infrared emitter.

In a third embodiment, with reference to the second embodiment, the substrate of the flat lens imaging device comprises an electrically tunable material.

In a fourth embodiment, with reference to any of embodiments 1-3, the at least one wavelength of infrared light comprises a plurality of wavelengths of infrared light.

In a fifth embodiment, with reference to any of embodiments 1-4, the flat lens imaging device is integrated with the infrared emitter.

In a sixth embodiment, with reference to any of embodiments 1-5, the infrared emitter comprises at least one light emitting diode.

In a seventh embodiment, a device comprises an infrared sensor and a flat lens imaging device configured to receive infrared light and adjust at least one wavelength of the infrared light onto a single location of the infrared sensor.

In an eighth embodiment, with reference to the seventh embodiment, the flat lens imaging device comprises a substrate and a plurality of optical antennas positioned on a surface of the substrate, wherein the optical antennas are configured to adjust the radiation angle of the at least one wavelength of infrared light.

In a ninth embodiment, with reference to the eighth embodiment, the substrate of the flat lens imaging device comprises an electrically tunable material.

In a tenth embodiment, with reference to any of embodiments 7-9, the at least one wavelength of infrared light comprises a plurality of wavelengths of infrared light.

In an eleventh embodiment, with reference to any of embodiments 7-10, the flat lens imaging device is configured to filter certain wavelengths of light such that the device does not include a separate bandpass filter.

In a twelfth embodiment, with reference to any of embodiments 7-11, the device further comprises at least one additional optical lens configured to adjust an additional wavelength of infrared light or further adjust the at least one wavelength of infrared light.

In a thirteenth embodiment, with reference to the twelfth embodiment, the at least one additional optical lens is a curvature lens or a diffraction lens.

In a fourteenth embodiment, with reference to the twelfth embodiment, the at least one additional optical lens is positioned between the infrared sensor and the flat lens imaging device.

In a fifteenth embodiment, with reference to any of embodiments 12-14, the flat lens imaging device is positioned between the infrared sensor and the at least one additional optical lens.

In a sixteenth embodiment, with reference to any of embodiments 7-15, the device further comprises a color filter positioned between the flat lens imaging device and the infrared sensor.

In a seventeenth embodiment, an infrared camera comprises an infrared sensor, a flat lens imaging device configured to receive infrared light and adjust at least one wavelength of the infrared light onto a single location of the infrared sensor, and a processor configured to analyze the at least one wavelength of infrared light received at the single location of the infrared sensor.

In an eighteenth embodiment, with reference to the seventeenth embodiment, the infrared camera is a night vision camera, a building inspection camera, a fault diagnosis camera, a medical imaging camera, a chemical imaging camera, a meteorology camera, or an astronomy camera.

In a nineteenth embodiment, with reference to the seventeenth or eighteenth embodiment, the infrared camera is an automotive night vision camera.

In a twentieth embodiment, with reference to any of embodiments 17-19, the infrared camera further comprises at least one additional optical lens configured to adjust an additional wavelength of infrared light or further adjust the at least one wavelength of infrared light, wherein the at least one additional optical lens is a curvature lens or a diffraction lens.

What is claimed is:

1. A device comprising:
an infrared emitter configured to emit at least one wavelength of infrared light across a radiation angle; and
a flat lens imaging device configured to receive the infrared light from the infrared emitter and narrow the radiation angle for the at least one wavelength of infrared light, providing an adjusted radiation angle.

2. A device of claim 1, wherein the flat lens imaging device comprises a substrate and a plurality of optical antennas positioned on a surface of the substrate, wherein the optical antennas are configured to adjust the radiation angle of the at least one wavelength of infrared light emitted from the infrared emitter.

3. A device of claim 2, wherein the substrate of the flat lens imaging device comprises an electrically tunable material.

4. A device of claim 1, wherein the at least one wavelength of infrared light comprises a plurality of wavelengths of infrared light.

5. A device of claim 1, wherein the flat lens imaging device is integrated with the infrared emitter.

6. A device of claim 1, wherein the infrared emitter comprises at least one light emitting diode.

7. A device comprising:
an infrared sensor; and
a flat lens imaging device configured to receive infrared light and adjust at least one wavelength of the infrared light onto a single location of the infrared sensor.

8. A device of claim 7, wherein the flat lens imaging device comprises a substrate and a plurality of optical antennas positioned on a surface of the substrate, wherein the optical antennas are configured to adjust the radiation angle of the at least one wavelength of infrared light.

9. A device of claim 8, wherein the substrate of the flat lens imaging device comprises an electrically tunable material.

10. A device of claim 7, wherein the at least one wavelength of infrared light comprises a plurality of wavelengths of infrared light.

11. A device of claim 7, wherein the flat lens imaging device is configured to filter certain wavelengths of light such that the device does not include a separate bandpass filter.

12. A device of claim 7, further comprising:
at least one additional optical lens configured to adjust an additional wavelength of infrared light or further adjust the at least one wavelength of infrared light.

13. A device of claim 12, wherein the at least one additional optical lens is a curvature lens or a diffraction lens.

14. A device of claim 12, wherein the at least one additional optical lens is positioned between the infrared sensor and the flat lens imaging device.

15. A device of claim 12, wherein the flat lens imaging device is positioned between the infrared sensor and the at least one additional optical lens.

16. A device of claim 7, further comprising a color filter positioned between the flat lens imaging device and the infrared sensor.

17. An infrared camera comprising:
an infrared sensor;
a flat lens imaging device configured to receive infrared light and adjust at least one wavelength of the infrared light onto a single location of the infrared sensor; and
a processor configured to analyze the at least one wavelength of infrared light received at the single location of the infrared sensor.

18. An infrared camera of claim 17, wherein the infrared camera is a night vision camera, a building inspection camera, a fault diagnosis camera, a medical imaging camera, a chemical imaging camera, a meteorology camera, or an astronomy camera.

19. An infrared camera of claim 17, wherein the infrared camera is an automotive night vision camera.

20. An infrared camera of claim 17, further comprising:
at least one additional optical lens configured to adjust an additional wavelength of infrared light or further adjust the at least one wavelength of infrared light,
wherein the at least one additional optical lens is a curvature lens or a diffraction lens.
